(19) United States
(12) Patent Application Publication
(10) Pub. No.: US 2024/0413581 A1
(43) Pub. Date: Dec. 12, 2024

(54) SECURING DEVICE HAVING AN IDENTIFYING FEATURE AS PART OF A SECOND IDENTIFYING FEATURE

(71) Applicant: Lisa Dräxlmaier GmbH, Vilsbiburg (DE)

(72) Inventors: Stefan WIMMER, Hohenthann (DE); Sebastian WILHELM, Schmelz (DE); Franziska NEUMAYER, Geisenhausen (DE)

(73) Assignee: Lisa Dräxlmaier GmbH, Vilsbiburg (DE)

(21) Appl. No.: 18/735,652

(22) Filed: Jun. 6, 2024

(30) Foreign Application Priority Data
Jun. 6, 2023 (DE) 102023114791.9

(51) Int. Cl. H01R 13/641; H01R 13/629

(52) U.S. Cl. CPC H01R 13/641; H01R 13/629

(57) ABSTRACT

A securing device for securing the locking of a locking element includes a locking element, which can be moved from a first locking position into a second locking position. The locking element produces locking in the second locking position. The securing device further includes an indicator element having an identifying feature for indicating an item of information. In the first locking position of the locking element, the identifying feature is part of a second identifying feature, and therefore the identifying feature cannot be discerned separately. In the second locking position of the locking element, the identifying feature is not part of the second identifying feature, and therefore the identifying feature can be discerned separately.

### CROSS-REFERENCE TO RELATED APPLICATIONS

This application claims priority to and the benefit of DE 10 2023 114 791.9 filed on Jun. 6, 2023. The disclosure of the above-referenced application is incorporated herein by reference.

### FIELD

The present disclosure relates to a securing device having an identifying feature to secure the locking of a locking element.

### BACKGROUND

The statements in this section merely provide background information related to the present disclosure and may not constitute prior art.

CPA (connector position assurance) systems are intended to inhibit a connector housing latched to a mating connector housing from being inadvertently detached from the mating connector housing, as can happen for example due to vibrations, temperature-related expansion or shrinkage, pulling on a cable accommodated in the connector housing, or other mechanical effects. For this, the CPA system is responsible for locking the connector to its mating connector, as the last element to be operated. In order to provide secure locking here, it is necessary for the final state of the locking to be detected by virtue of a scannable element and for this element to be readable when the CPA system is finally closed.

### SUMMARY

This section provides a general summary of the disclosure and is not a comprehensive disclosure of its full scope or all of its features.

The present disclosure relates to a securing device having an identifying feature (primary identifying feature) as part of a second identifying feature (secondary identifying feature). The securing device serves to secure the locking of a locking element or for connector position assurance (CPA) and can be used to secure the locking of a connector housing to a mating connector housing. In particular, the present disclosure relates to a CPA system having a detectable sub-element.

The present disclosure provides a suitable device which makes it possible to reliably discern if locking is present or not, in particular for connectors for which CPA locking is desired.

The connector may have a high degree of automation in terms of production and fabrication makes the use of a scannable element desired as an assurance function. The present disclosure presented here relates to a securing device including an indicator element having an identifying feature and a contrasting element, wherein a contrast of the identifying feature is modified by the contrasting element and the indicator element can therefore be used as a scannable element, in order to provide reliable assurance of the connector production process and make it possible to scan the plug system in the assembled state. The solution presented here can be applied to various plug systems and can be easily adapted from one plug system to another plug system.

The main feature of the solution according to the present disclosure is an element to be detected, which is on the CPA system and can be detected after the CPA system is actuated. Furthermore, this element cannot be detected in the open position of the CPA system, in that either it is a sub-element of another element to be detected or the contours are manipulated.

According to a first aspect, the present disclosure provides a securing device for securing the locking of a locking element, wherein the securing device includes the following: a locking element, which can be moved from a first locking position into a second locking position, wherein the locking element produces locking in the second locking position; an indicator element having an identifying feature for indicating an item of information; wherein, in the first locking position of the locking element, the identifying feature is part of a second identifying feature, and therefore the identifying feature cannot be discerned separately; and wherein, in the second locking position of the locking element, the identifying feature is not part of the second identifying feature, and therefore the identifying feature can be discerned separately.

Here, the identifying feature is also referred to as primary identifying feature and the second identifying feature as secondary identifying feature.

The item of information may be any desired item of information. In particular, the item of information is an item of information regarding locking or non-locking by the locking element. The item of information may additionally also contain other things, for example user information, serial number of the securing device or of individual components of the device, instructions for the user, etc.

Such a securing device affords the technical advantage that it is possible to securely and reliably discern locking. The indicator element having the identifying feature can be detected via a scannable element, with the result that it is possible to reliably automatically discern the item of information and thus a position of the locking element. This also makes it possible to automatically detect the state of connectors for which CPA locking is desired. The securing device thus meets the standards for CPA locking.

The identifying feature may, for example, be a code, for example a one- or multi-dimensional code, or a pictogram or a symbol.

According to one example of the securing device, in both of the locking positions of the locking element, the identifying feature is not concealed and always remains visible.

This affords the technical advantage that covering the indicator element having the identifying feature to achieve the desired effect of non-discernibility may be omitted. The modification of the identifying feature, in that the identifying feature is part of a second identifying feature, is already sufficient to make the identifying feature unrecognizable, so that the identifying feature can no longer be detected or discerned separately by a scannable element. The scannable element can then only detect the second identifying feature, but not the identifying feature as a separate unit.

According to one example of the securing device, when the locking element is being moved from the first locking position into the second locking position, the identifying feature is made to slide out of the second identifying feature, and therefore the identifying feature can be discerned separately in the second locking position.

This affords the technical advantage that an ability to discern the identifying feature can be easily controlled by actuation of the locking element. When the locking element is actuated by being moved into the second locking position, the identifying feature is made to move out of the second identifying feature and can be discerned as a separate feature, which is no longer part of the second identifying feature, and therefore it is possible to reliably discern the presence of a locking effect.

According to one example of the securing device, in the first locking position, the second identifying feature completely or at least partially surrounds the identifying feature.

This affords the technical advantage that the identifying feature can no longer be discerned as a separate feature as a result and it can thus be reliably inferred from this that the locking element is in the first locking position, and therefore no locking is present. A widening of the edge of the identifying feature is also already sufficient for it to no longer be discernible separately.

According to one example of the securing device, the identifying feature has contours which delimit the identifying feature with respect to a surrounding area; wherein, in the first locking position, the contours of the identifying feature are made unrecognizable or obfuscated by the second identifying feature; and wherein, in the second locking position, the contours of the identifying feature are not made unrecognizable or obfuscated by the second identifying feature.

This affords the technical advantage that the obfuscation of the contours of the identifying feature has the effect that it can no longer be discerned separately, with the result that it is possible to make a distinction between the “locked” and “unlocked” states.

According to one example of the securing device, the identifying feature includes a code, for example a one- or multi-dimensional code; and the second identifying feature includes a second code, for example a second one- or multi-dimensional code; wherein the code is not discernible when it is part of the second code.

This affords the technical advantage that it is easily possible to be able to make a distinction on the basis of codes. Codes suitable for this, for example 1D, 2D or 3D codes, have a strong contrast, and can therefore be read easily by a reading element.

According to one example of the securing device, the identifying feature includes a one-dimensional or multi-dimensional code, for example a data matrix code, DMC, or a QR code or a barcode.

The data matrix code is one of the best known 2D codes and can be used for permanent and robust direct labelling. The DMC is variable in size and thus permits a multiplicity of symbol elements. QR codes and barcodes are also suitable as identifying feature and/or second identifying feature.

According to one example of the securing device, the identifying feature is discernible when it is not part of the second identifying feature.

This affords the technical advantage that the state of the locking element can be discerned securely and reliably, for example can be determined via a reader or a scanner. This makes it possible to efficiently assure automated mounting of plug systems.

According to one example of the securing device, the securing device is designed to perform connector position assurance (CPA) to secure the locking of a connector housing to a mating connector housing.

This affords the technical advantage that the state of the CPA system can be reliably detected by virtue of a scannable element, which is readable only when the CPA system is finally closed.

According to one example of the securing device, the securing device also includes: a clamping element for clamping the connector housing into the mating connector housing, wherein the clamping element can be moved from an open clamping-element position, in which the connector housing can be inserted into the mating connector housing, into a closed clamping-element position, in which the connector housing is fastened to the mating connector housing with electrical contact; wherein the locking element is placed on the clamping element and designed to lock or to unlock the clamping element. As already described above, the indicator element indicates an item of information, for example an item of information about the locking of the clamping element by the locking element.

This affords the technical advantage that the indicator element reliably indicates an item of information, for example an item of information regarding the locking of the clamping element, for example a clip, so that the state of the clamping element can be reliably discerned, for example by way of a scannable element.

According to one example of the securing device, in the closed clamping-element position, the locking element can be moved from the first locking position into the second locking position and is designed, in the second locking position, to lock the clamping element in the closed clamping-element position and, in the first locking position, to unlock the clamping element for a movement into the open clamping-element position.

This affords the technical advantage that a secure connection of the connector housing to the mating connector housing via the clamping element is provided. The securing device thus meets the standards for CPA locking.

According to one example of the securing device, the identifying feature and the second identifying feature are placed on the clamping element; and a movement of the locking element from the first locking position into the second locking position makes the identifying feature slide out of the second identifying feature, and therefore the identifying feature can be discerned separately in the second locking position.

This affords the technical advantage that the indicator element can reliably and robustly indicate an item of information, for example an item of information regarding locking. In the first locking position, the identifying feature is enclosed by a second identifying feature, and therefore the identifying feature cannot be discerned separately and no information (for example an item of information about the locking) can be discerned. In the second locking position, the identifying feature is no longer enclosed by the second identifying feature, and therefore the identifying feature can be discerned separately, for example via a scannable element or visually by a user.

According to a second aspect, the present disclosure provides a plug connection having a connector housing and a mating connector housing, which are connected to one another and secured by a securing device according to the first aspect.

According to a third aspect, the present disclosure provides a securing system including a securing device according to the first aspect and a reader, wherein the reader is designed to detect the identifying feature of the indicator element when the locking element is in the second locking position, in order to discern an item of information, for example an item of information about the locking.

According to one example of the securing system, the reader is designed to detect the identifying feature of the indicator element only when the locking element is in the second locking position and to detect correct locking only in this position.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic illustration of the states of a securing device according to the present disclosure;

FIG. 2A shows an illustration of a securing device according to the present disclosure in the first locking position, in which the identifying feature is part of a second identifying feature;

FIG. 2B shows an illustration of the securing device according to FIG. 2A in the second locking position, in which the identifying feature is not part of the second identifying feature;

FIG. 3A shows an illustration of a further example, in which, in the first locking position, the identifying feature is part of a second identifying feature;

FIG. 3B shows an illustration of the example from FIG. 3A, in which, in the second locking position, the identifying feature is not part of the second identifying feature;

FIG. 4A shows a perspective view of a securing device including a locking element, an indicator element having an identifying feature, and a clamping element in a closed clamping-clip position, in which the locking element is in the first locking position; and

FIG. 4B shows a perspective view of the securing device from FIG. 4A, in which the locking element is in the second locking position.

The figures are merely schematic illustrations and serve only to explain the present disclosure. Elements that are the same or have the same effect are provided with the same reference signs throughout.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the detailed description that follows, reference is made to the accompanying drawings, which form a part thereof and which show, as an illustration, specific examples in which the present disclosure can be carried out. It goes without saying that other examples can also be used and structural or logical changes can be made without departing from the concept of the present disclosure. The detailed description that follows should therefore not be understood in a restrictive sense. It also goes without saying that the features of the various examples described herein can be combined with one another unless specifically stated otherwise.

The aspects and examples are described with reference to the drawings, wherein reference signs that are the same generally relate to the same elements. Numerous specific details are set out for the purposes of explanation in the description that follows in order to provide an in-depth understanding of one or more aspects of the present disclosure. However, it may be obvious to a person skilled in the art that one or more aspects or examples can be implemented with a lesser degree of the specific details. In other cases, known structures and elements are illustrated in a schematic form in order to make it easier to describe one or more aspects or examples. It goes without saying that other examples can be used and structural or logical changes can be made without departing from the concept of the present disclosure.

In order to provide secure locking here, it is desired for the final state of the locking to be detected by virtue of a scannable element and for this element to be readable only when the CPA system is finally closed.

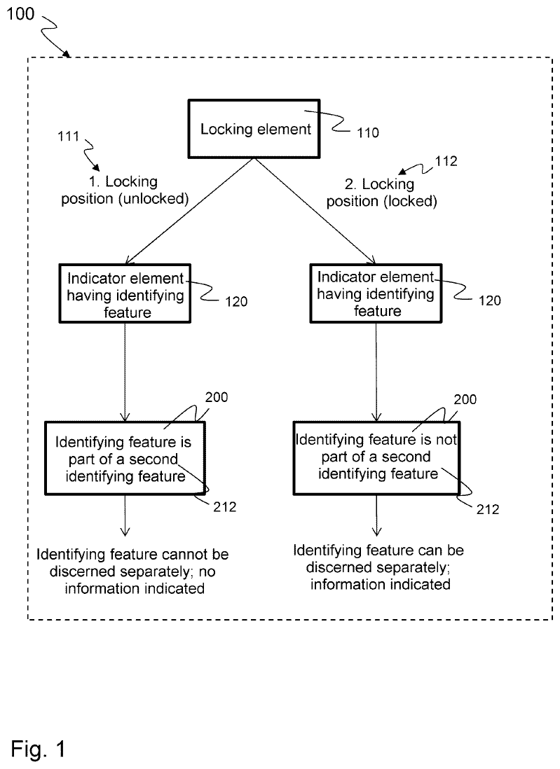

FIG. 1 shows a schematic illustration of the states of a securing device 100 according to the present disclosure.

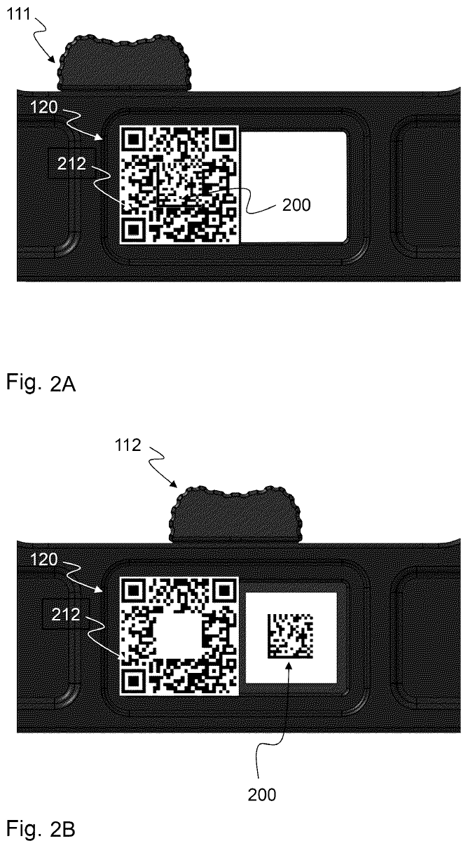

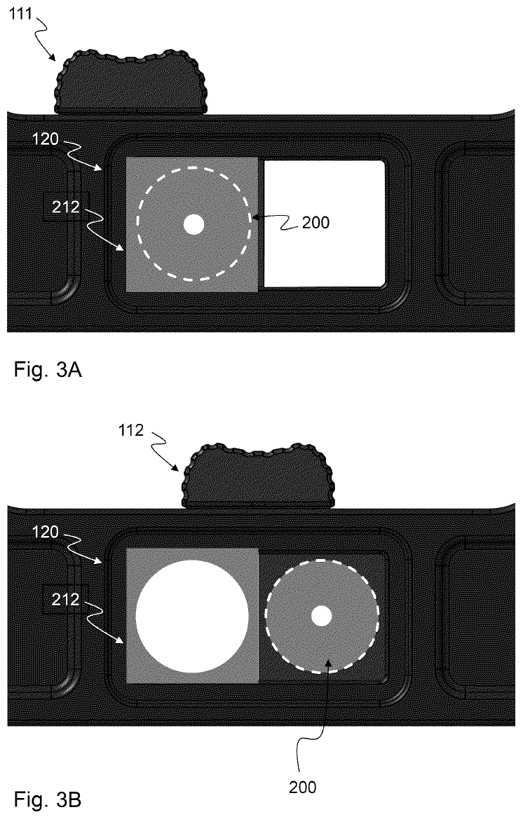

The securing device 100 serves to secure the locking of a locking element 110. The securing device 100 includes a locking element 110 and an indicator element 120 having an identifying feature 200 (see also FIGS. 2A and 2B, and 3A and 3B).

The locking element 110 can be moved from a first locking position 111 into a second locking position 112 and produces locking in the second locking position 112.

The indicator element 120 having the identifying feature 200 (see FIGS. 2A and 2B, and 3A and 3B) serves to indicate an item of information, for example an item of information about the locking by the locking element 110.

In the first locking position 111 of the locking element 110, the identifying feature 200 is part of a second identifying feature 212, and therefore the identifying feature 200 cannot be discerned separately.

In the second locking position 112 of the locking element 110, the identifying feature 200 is not part of the second identifying feature 212, and therefore the identifying feature 200 can be discerned separately (see also FIGS. 2A and 2B, and 3A and 3B).

In both of the locking positions 111, 112 of the locking element 110, the identifying feature 200 is not concealed and always remains visible, as set out in more detail below in relation to FIGS. 2A and 2B or 3A and 3B.

One example of the identifying feature 200 and of the second identifying feature 212 is illustrated and described in more detail in FIGS. 2A and 2B, and 3A and 3B.

FIGS. 2A and 2B show illustrations of a securing device 100 according to the present disclosure as per one example in the first locking position (FIG. 2A), in which the identifying feature 200 is part of a second identifying feature 212, and in the second locking position (FIG. 2B), in which the identifying feature 200 is not part of the second identifying feature 212.

The securing device 100 in FIG. 2A and FIG. 2B corresponds to the securing device described above in relation to FIG. 1, with FIG. 2A and FIG. 2B illustrating the structure of this securing device 100 in more detail.

As already described above in relation to FIG. 1, the securing device 100 serves to secure the locking of a locking element 110. The securing device 100 includes a locking element 110 and an indicator element 120 having an identifying feature 200 and a second identifying feature 212, as illustrated in FIGS. 2A and 2B.

The locking element 110 can be moved from a first locking position 111 into a second locking position 112 and produces locking in the second locking position 112. FIG. 2A illustrates the locking element 110 in the first locking position 111; FIG. 2B illustrates the locking element in the second locking position 112.

The indicator element 120 having the identifying feature 200 (see FIGS. 2A and 2B) serves to indicate an item of information, for example an item of information about the locking by the locking element 110. FIGS. 2A and 2B illustrate the identifying feature as a two-dimensional code with white and black elements or pixels. The 2D code is, for example, a DMC.

As already described above in relation to FIG. 1, in the first locking position 111 of the locking element 110, the identifying feature 200 is part of a second identifying feature 212, and therefore the identifying feature 200 cannot be discerned separately.

In the second locking position 112 of the locking element 110, the identifying feature 200 is not part of the second identifying feature 212, and therefore the identifying feature 200 can be discerned separately.

In both of the locking positions 111, 112 of the locking element 110, the identifying feature 200 is not concealed and always remains visible.

When the locking element 110 is being moved from the first locking position 111 (see FIG. 2A) into the second locking position 112 (see FIG. 2B), the identifying feature 200 is made to slide out of the second identifying feature 212, and therefore the identifying feature 200 can be discerned separately in the second locking position 112 (see FIG. 2B).

As FIG. 2A shows, in the first locking position 111, the second identifying feature 212 surrounds the identifying feature 200. As an alternative, the second identifying feature 212 may also partially surround the identifying feature 200, for example only on one side or at a corner.

The identifying feature 200 has contours, which delimit the identifying feature 200 with respect to a surrounding area. In the first locking position 111, the contours of the identifying feature 200 are obfuscated by the second identifying feature 212 (see FIG. 2A). In the second locking position 112, the contours of the identifying feature 200 are not obfuscated by the second identifying feature 212 (see FIG. 2B), since the identifying feature 200 has been made to slide out of the second identifying feature 212 and the identifying feature 200 contours have been made discernible as a result.

In the example of FIGS. 2A and 2B, the identifying feature 200 includes a code, for example a two-dimensional code, as illustrated in the figures. The second identifying feature 212 includes a second code, for example a second two-dimensional code, as illustrated in the figures, which may differ from the two-dimensional code of the identifying feature 200. The two-dimensional code is not discernible when it is part of the second two-dimensional code, as illustrated in FIG. 2A. In another example the identifying feature 200 includes a one-dimensional or multi-dimensional code.

As depicted in the example of FIGS. 2A and 2B, the identifying feature 200 or the 2D code may include a data matrix code, DMC. This may, for example, also be a barcode.

Such a data matrix code includes or consists, for example, of the following main components:
1) two pairs of solid continuous edges and interrupted edges as boundary lines (finder pattern or position marker). The solid boundary lines serve for delimitation. They are used to align and equalize the data matrix code, so that any reading angle is possible.
2) a peripheral quiet zone. This empty zone surrounds the data matrix code. The peripheral quiet zone does not contain any information or patterns. The width of the quiet zone is at least one gap or line (in one example four times the width, or height, of a module) and is desired for delimitation from other optical image elements of the surrounding area.
3) the corner situated opposite the closed edges. This corner makes it possible to quickly discern the code schemata. In the case of the identifying feature 200 or code scheme ECC, with an even number of lines and gaps, the element in the upper right-hand corner is white. In the case of the other standardized code schemata, with an odd number of lines and gaps, the element in the upper right-hand corner is black.
4) the alignment pattern. This combination in pairs of continuous and interrupted lines in both directions, horizontally and vertically, makes it easier to evaluate the image. They subdivide large data fields into equally sized parts in the case of codes with an edge length of at least 32 modules.
5) the data area. This data area contains the actual binary information in coded form. Depending on the size of the matrix, the number of possible items of information is also defined in this way.

The identifying feature 200 or the 2D code or the DMC can be discerned, for example read via a reader, when the identifying feature 200 is not part of the second identifying feature 212 or the second 2D code or the second DMC.

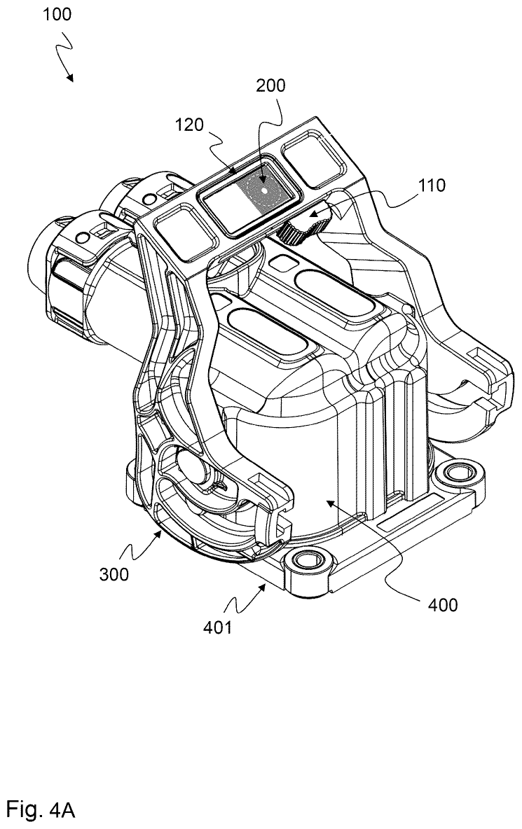

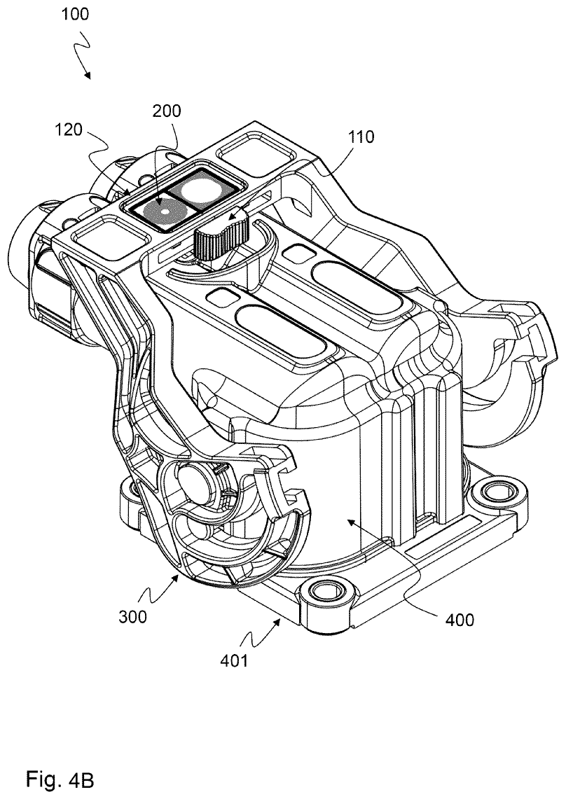

The securing device 100 may be designed to perform connector position assurance (CPA) to secure the locking of a connector housing 400 to a mating connector housing 401, as described in more detail below in relation to FIG. 4A.

An example with a CPA system in which the identifying feature 200 is a DMC including black and white pixels, as illustrated in FIGS. 2A and 2B, will be described below.

The element to be detected, i.e. the identifying feature 200, illustrated as a DMC in FIGS. 2A and 2B, is always on the CPA system and is always completely visible. However, in the first locking position 111, or position 1, this identifying feature 200 or element is a sub-element of a larger element to be detected, i.e. of the second identifying feature 212, or is non-detectable by virtue of the fact that it is a sub-element. Only the larger element (the second identifying feature 212 or the second detectable element) can, if desired, be detected in position 1 and conveys, for example, the “open” status.

After the CPA system is actuated, in the second locking position 112, or position 2, only the identifying feature 200 or DMC on the CPA system is scannable, since the DMC as sub-element is also scannable on its own.

The securing device 100, as described above in relation to FIGS. 1 and 2A and 2B, and a reader make it possible to implement a securing system which can reliably determine the state of the locking element 110 and transfer this state, for example to a controller, for further processing. Such a securing system includes a securing device 100 as described above and a reader. The reader is designed to detect the identifying feature 200 of the indicator element 120 when the locking element 110 is in the second locking position 112, i.e. when the identifying feature 200 is not part of the second identifying feature 212, in order to thus discern locking.

The reader may be designed to detect the identifying feature 200 only when the locking element 110 is in the second locking position 112 and to detect correct locking only in this position 112.

The reader may forward the detected information, for example the read-out 2D code or DMC, to a controller, which then can indicate a fault if it detects one and take corresponding steps to control the production or fabrication process.

FIGS. 3A and 3B show an illustration of a further example, in which, in the first locking position 111, the identifying feature 200 is part of a second identifying feature 212 (FIG. 3A) and in which, in the second locking position 112, the identifying feature 200 is not part of the second identifying feature 212 (FIG. 3B).

FIGS. 3A and 3B show the same principle, as set out above in relation to FIGS. 2A and 2B, as an alternative concept.

Here, the identifying feature 200 or circle, which corresponds to the identifying feature 200, is on the CPA system and, in the first locking position 111 (see FIG. 3A), is a sub-element of a quadrilateral, which corresponds to the second identifying feature 212. In the first locking position 111 (FIG. 3A), the identifying feature 200 or circle is not scannable, since it is a constituent part of a quadrilateral, i.e. part or a constituent part of the second identifying feature 212. In the second locking position 112 (see FIG. 3B), it is detectable, since here the contours are clearly discernible.

FIGS. 4A and 4B show perspective views of a securing device 100 including a locking element 110, an indicator element 120 having an identifying feature 200, and a clamping element 300 in a closed clamping-clip position. The locking element 110 is in the first locking position 111 in FIG. 4A and in the second locking position 112 in FIG. 4B. The locking element 110 may be moved between the two locking positions 111, 112.

The securing device 100 is designed to perform connector position assurance (CPA) to secure the locking of a connector housing 400 to a mating connector housing 401.

In addition to the locking element 110 and indicator element 120 having an identifying feature 200 and a second identifying feature 212 that are already described above, the securing device 100 also includes a clamping element 300, for example a clamping clip, for clamping the connector housing 400 into the mating connector housing 401.

The clamping element 300 can be moved from an open clamping-element position, in which the connector housing 400 can be inserted into the mating connector housing 401, into a closed clamping-element position, in which the connector housing 400 is fastened to the mating connector housing 401 with electrical contact.

The locking element 110 is placed on the clamping element 300, as illustrated in FIGS. 4A and 4B, for example on a panel on the clamping element 300, as shown in FIGS. 4A and 4B, and is designed to lock or to unlock the clamping element 300.

The identifying feature 200 of the indicator element 120 indicates an item of information, for example an item of information about the locking of the clamping element 300 by the locking element 110. FIGS. 4A and 4B illustrate the identifying feature 200 of the indicator element 120 by way of example, using the circle already described in relation to FIGS. 3A and 3B. Of course, the identifying feature 200 may also take another form, for example a code as described above in relation to FIGS. 2A and 2B.

In the closed clamping-element position, the locking element 110 can be moved from the first locking position 111 (see FIG. 4A) into the second locking position 112 (see FIG. 4B). The locking element 110 is designed, in the second locking position 112, to lock the clamping element 300 in the closed clamping-element position and, in the first locking position 111, to unlock the clamping element 300 for a movement into the open clamping-element position. FIG. 4A illustrates an intermediate position of the clamping element 300 or clamping clip; the locking element 110 is thus in the open, non-locked first locking position 111.

The indicator element 120 having the identifying feature 200 is placed on the clamping element 300, for example on a panel on the clamping element 300, as illustrated in FIGS. 4A and 4B. Furthermore, the second identifying feature 212 is also placed on the clamping element 300, as illustrated in FIGS. 4A and 4B.

When the locking element 110 is being moved from the first locking position 111 into the second locking position 112, the identifying feature 200 is made to slide or move out of the second identifying feature 212, and therefore the identifying feature 200 can be discerned separately in the second locking position 112 (see FIG. 4B).

FIGS. 4A and 4B thus also show a plug connection having a connector housing 400 and a mating connector housing 401, which are connected to one another and secured by the securing device 100 as described above.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A securing device for securing a locking of a locking element, comprising:
the locking element that is configured to move from a first locking position into a second locking position and the locking element is configured to lock in the second locking position; and
an indicator element including an identifying feature configured to indicate an item of information, in the first locking position of the locking element, the identifying feature is part of a second identifying feature and is not discernible separately in the first locking position and in the second locking position of the locking element, the identifying feature is not part of the second identifying feature, and the identifying feature is configured to be discerned separately when the locking element is in the second locking position.

2. The securing device according to claim 1, wherein, in both the first locking position and the second locking position of the locking element, the identifying feature is not concealed and remains visible.

3. The securing device according to claim 1, wherein the identifying feature is configured to slide out of the second identifying feature based on a movement of the locking element from the first locking position into the second locking position, and the identifying feature is discerned separately in the second locking position.

4. The securing device according to claim 1, wherein, in the first locking position, the second identifying feature completely or at least partially surrounds the identifying feature.

5. The securing device according to claim 4, wherein the identifying feature includes a code, the second identifying feature includes a second code and the code is not discernible when the code is part of the second code.

6. The securing device according to claim 1, wherein, in the first locking position, the second identifying feature completely surrounds the identifying feature.

7. The securing device according to claim 1, wherein the identifying feature includes contours configured to delimit the identifying feature with respect to a surrounding area, in the first locking position, the contours of the identifying feature are obfuscated by the second identifying feature and in the second locking position, the contours of the identifying feature are not obfuscated by the second identifying feature.

8. The securing device according to claim 6, wherein the identifying feature includes a code, the second identifying feature includes a second code and the code is not discernible when the code is part of the second code.

9. The securing device according to claim 1, wherein the identifying feature includes a one-dimensional code.

10. The securing device according to claim 1, wherein the identifying feature includes a multi-dimensional code.

11. The securing device according to claim 1, wherein the identifying feature is discernible when the identifying feature is not part of the second identifying feature.

12. The securing device according to claim 1, wherein the securing device is configured to perform connector position assurance (CPA) to secure a lock between a connector housing and a mating connector housing.

13. The securing device according to claim 12, further comprising:
a clamping element configured to clamp the connector housing into the mating connector housing, the clamping element configured to move from an open clamping-element position, in which the connector housing is insertable into the mating connector housing, into a closed clamping-element position, in which the connector housing is fastened to the mating connector housing with electrical contact; and
wherein the locking element is placed on the clamping element and configured to lock or to unlock the clamping element.

14. The securing device according to claim 13, wherein, in the closed clamping-element position, the locking element is configured to move from the first locking position into the second locking position and is configured, in the second locking position, to lock the clamping element in the closed clamping-element position and, in the first locking position, to unlock the clamping element for a movement into the open clamping-element position.

15. The securing device according to claim 14,
wherein the identifying feature and the second identifying feature are placed on the clamping element; and
a movement of the locking element from the first locking position into the second locking position slides the identifying feature out of the second identifying feature, and the identifying feature is discernible separately in the second locking position.

16. The securing device according to claim 13, wherein the identifying feature and the second identifying feature are placed on the clamping element, a movement of the locking element from the first locking position into the second locking position slides the identifying feature out of the second identifying feature, and the identifying feature is discernible separately in the second locking position.
